(19) United States
(12) Patent Application Publication
(10) Pub. No.: US 2016/0193982 A1
(43) Pub. Date: Jul. 7, 2016

(54) Adjusting Structure For Ratchet Safety Belt

(71) Applicant: Taiwan Racing Products Co., Ltd., Changhua County (TW)

(72) Inventor: Wen-Yuan Wu, Changhua County (TW)

(21) Appl. No.: 14/590,181

(22) Filed: Jan. 6, 2015

(51) Int. Cl. B60R 22/34; B25B 13/48; B25B 15/00; B25B 13/46

(52) U.S. Cl. CPC B60R 22/34; B60R 22/3416; B25B 13/46; B25B 13/48; B25B 15/008

(57) ABSTRACT

An adjusting structure for a ratchet safety belt contains: a body and a rotating member for matching with a fixed section and a movable section of the ratchet safety belt. The body includes a holder having two parallel side plates, a fixing plate, and an abutting plate. Each side plate has an orifice and a slot. A rotary shaft inserts into and extends out of the orifice and has a through hole. Each of two ratchets is coupled with each end of the rotary shaft and has plural teeth. A driving member is joined with the rotary shaft and has a drive portion. A retainer is slidably mounted in two slots of the two side plates and has two shoulders. A first spring is fixed between the abutting plate and the retainer, and a rotating member includes a fitting portion for fitting with the drive portion of the driving member.

### BACKGROUND OF THE INVENTION

1. Field of the Invention

The present invention relates to an adjuster for a safety belt, and more particularly to an adjusting structure for a ratchet safety belt.

2. Description of the Prior Art

A conventional safety belt is fixed in a vehicle to protect a driver and passenger(s). For example, in a car crash, the conventional safety belt ties the driver and the passenger(s) securely on seats to avoid the driver and the passenger(s) falling out of the vehicle.

The conventional safety belt is formed in a three-point type or in a multi-point type for a racing car, wherein a multi-point type safety belt ties a racer on a racing seat tightly and contains an adjuster for adjusting a desired length of the multi-point type safety belt as unfastening the multi-point type safety belt, such that the racer fastens plural retainers with a buckle of the multi-point type safety belt easily and quickly. Thereafter, an adjustable strap on one end of the adjuster is pulled so that the multi-point type safety belt ties the racer on the racing seat securely. However, the adjuster loses easily as the racing car vibrates during driving, and when the adjuster is located at a specific angle relative to the adjustable strap, the adjustable strap is too tight to be pulled or to be released easily.

The present invention has arisen to mitigate and/or obviate the afore-described disadvantages.

### SUMMARY OF THE INVENTION

The primary objective of the present invention is to provide an adjusting structure for a ratchet safety belt which contains two shoulders, and each shoulder engages with one of plural teeth of each of two ratchets without removal as vibration, and a rotating member drives a driving member and a rotary shaft to revolve, thus rolling and pulling a movable section of the ratchet safety belt tightly.

Another objective of the present invention is to provide an adjusting structure for a ratchet safety belt which after rotating a rotatable tab of the retainer away from the rotary shaft, each shoulder of the retainer disengages from the one of the plural teeth of each ratchet, thus releasing the retainer easily.

To obtain above-mentioned objectives, an adjusting structure for a ratchet safety belt provided by the present invention contains: a body and a rotating member for matching with a fixed section and a movable section of a ratchet safety belt.

The body includes a holder, a rotary shaft, two ratchets, a driving member, a retainer, a first spring, and a rotating member.

The holder has two parallel side plates, a fixing plate defined on a first end between two sides of the holder, and an abutting plate arranged on a second end between the two sides of the holder, wherein the fixing plate is connected with the fixing section, each side plate has an orifice defined thereon and a slot formed adjacent to the orifice.

The rotary shaft inserts into and extends out of the orifice of each side plate, and the rotary shaft has a through hole defined on a middle section thereof to insert through the movable section of the ratchet safety belt.

Each ratchet is coupled with each end of the rotary shaft which extends out of the orifice and rotates with each ratchet, and each ratchet has plural teeth arranged around a peripheral side thereof.

The driving member is joined with one end of the rotary shaft which extends out of the orifice, such that the driving member rotates with the rotary shaft, and the driving member has a drive portion arranged on one end thereof away from the holder.

The retainer is slidably mounted in two slots of the two side plates of the holder, wherein the retainer has two shoulders formed on two sides of a first end thereof and extending out of the two slots of the two side plates to limit a rotation of each ratchet along the rotary shaft in a single direction.

The first spring is fixed between the abutting plate and the retainer of the holder, such that the retainer is pushed by the first spring to move close to the rotary shaft, and each shoulder of the retainer engages with one of the plural teeth of each ratchet;

The rotating member includes a fitting portion for fitting with the drive portion of the driving member to drive the driving member to rotate, and the rotary shaft and the two ratchets are driven by the rotary shaft to rotate, thus rolling and pulling the moving section of the racket safety belt tightly.

### BRIEF DESCRIPTION OF THE DRAWINGS

FIG. 1 is a perspective view showing the assembly of an adjusting structure for a ratchet safety belt according to a preferred embodiment of the present invention.

FIG. 2 is a perspective view showing the assembly of a body of the adjusting structure for the ratchet safety belt according to the preferred embodiment of the present invention.

FIG. 3 is a perspective view showing the exploded components of the body of the adjusting structure for the ratchet safety belt according to the preferred embodiment of the present invention.

FIG. 4 is a perspective view showing the exploded components of a ratchet wrench of the adjusting structure for the ratchet safety belt according to the preferred embodiment of the present invention.

FIG. 5 is a perspective view showing the operation of the adjusting structure for the ratchet safety belt according to the preferred embodiment of the present invention.

FIG. 6 is a side plan view showing the operation of the adjusting structure for the ratchet safety belt according to the preferred embodiment of the present invention.

FIG. 7 is a cross sectional view showing the operation of the adjusting structure for the ratchet safety belt according to the preferred embodiment of the present invention.

FIG. 8 is another side plan view showing the operation of the adjusting structure for the ratchet safety belt according to the preferred embodiment of the present invention.

FIG. 9 a perspective view showing the assembly of an adjusting structure for a ratchet safety belt according to another preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

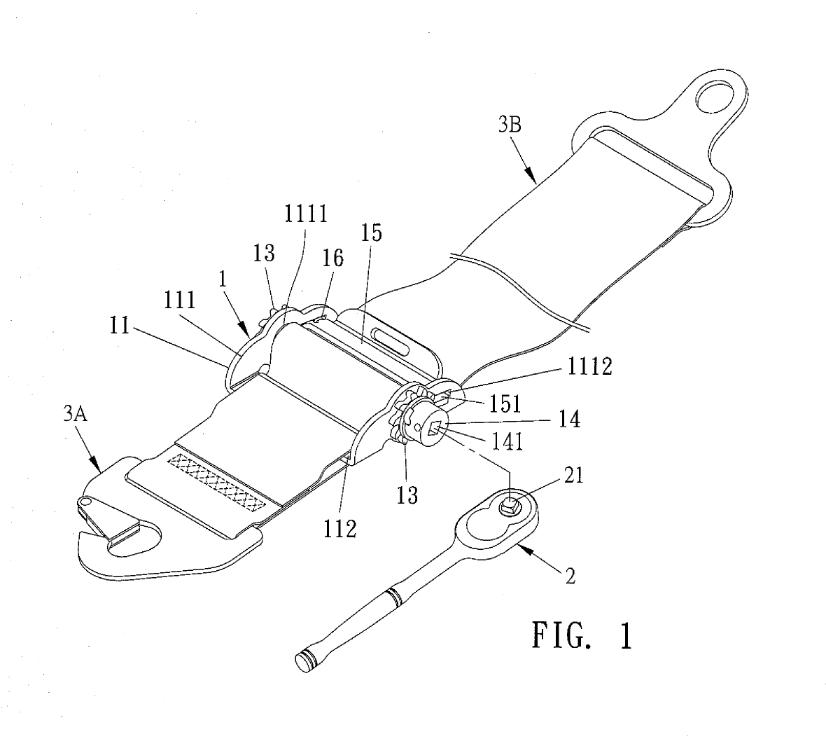

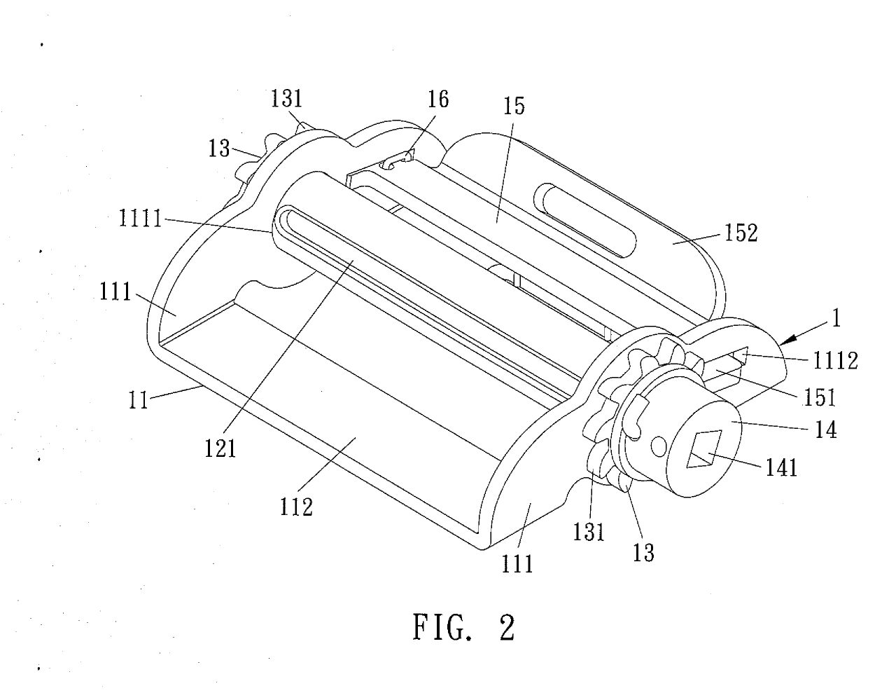

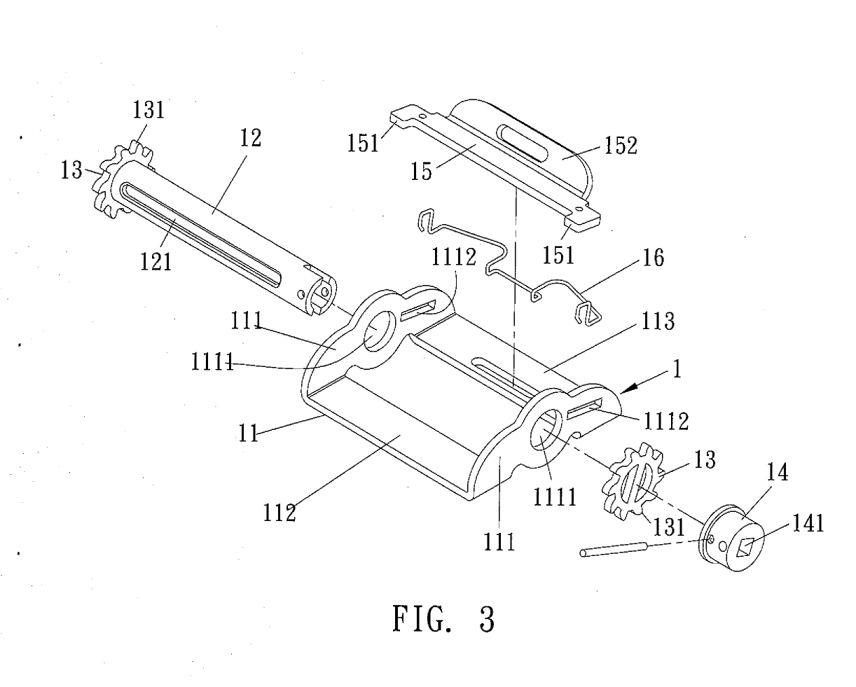

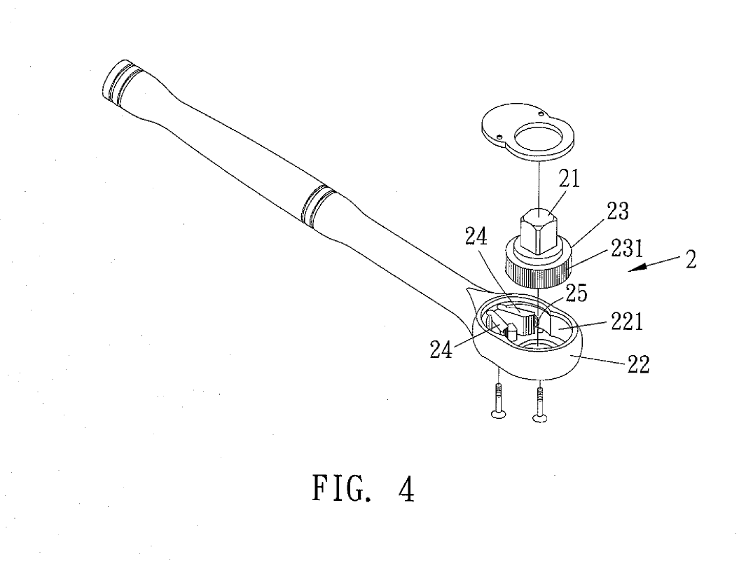

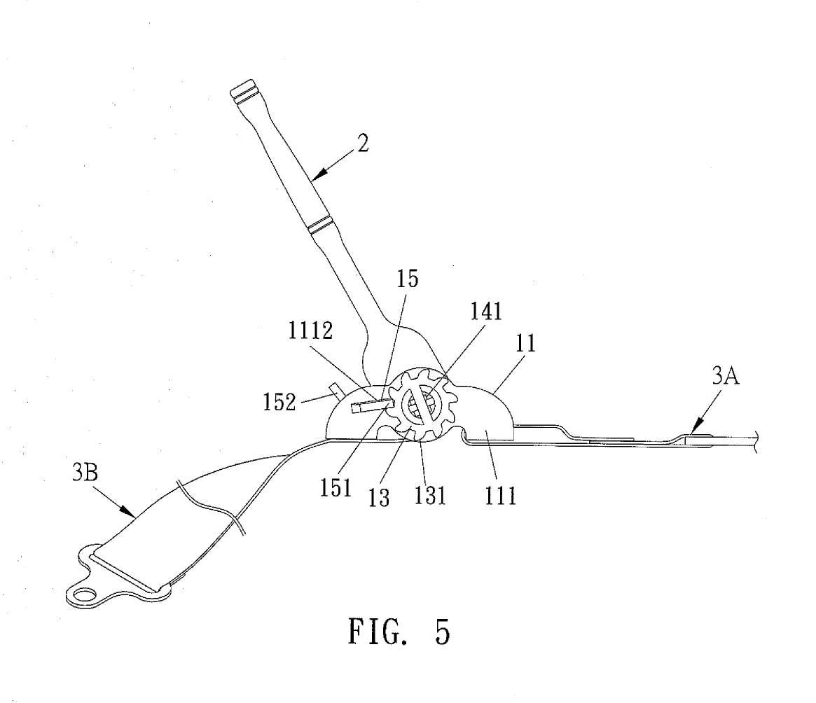

With reference to FIGS. 1 to 5, an adjusting structure for a ratchet safety belt according to a preferred embodiment of the present invention comprises: a body 1 and a rotating member 2 for matching with a fixed section 3A and a movable section 3B of the ratchet safety belt. The body 1 includes a holder 11, a rotary shaft 12, two ratchets 13, a driving member 14, a retainer 15, and a first spring 16. The holder 11 has two parallel side plates 111, a fixing plate 112 defined on a first end between two sides of the holder 11, and an abutting plate 113 arranged on a second end between the two sides of the holder 11, wherein the fixing plate 112 is connected with the fixing section 3A, each side plate 111 has an orifice 1111 defined thereon and a slot 1112 formed adjacent to the orifice 1111, wherein the rotary shaft 12 inserts into and extends out of the orifice 1111 of each side plate 111, and the rotary shaft 12 has a through hole 121 defined on a middle section thereof to insert through the movable section 3B of the ratchet safety belt. Each ratchet 13 is coupled with each end of the rotary shaft 12 which extends out of the orifice 1111 and rotates with each ratchet 13, and each ratchet 13 has plural teeth 131 arranged around a peripheral side thereof. The driving member 14 is joined with one end of the rotary shaft 12 which extends out of the orifice 1111, such that the driving member 14 rotates with the rotary shaft 12. The driving member 14 has a drive portion 141 arranged on one end thereof away from the holder 11. In this embodiment, the drive portion 141 is a square aperture, and the retainer 15 is slidably mounted in two slots 1112 of the two side plates 111 of the holder 11, wherein the retainer 15 has two shoulders 151 formed on two sides of a first end thereof and extending out of the two slots 1112 of the two side plates 111, the retainer 15 also has a rotatable tab 152 extending outwardly from a second end thereof. The first spring 16 is fixed between the abutting plate 113 and the retainer 15 of the holder 11, such that the retainer 15 is pushed by the first spring 16 to move close to the rotary shaft 12, and then each shoulder 151 of the retainer 15 engages with one of the plural teeth 131 of each ratchet 13, thus limiting a rotation of each ratchet 13 along the rotary shaft 12 in a single direction. The rotating member 2 includes a fitting portion 21 for fitting with the drive portion 141 of the driving member 14 to drive the driving member 14 to rotate. In this embodiment, the rotating member 2 is a ratchet wrench, and the ratchet wrench includes a working segment 22 with an accommodating cavity 221 defined in the working segment 22, a tool head 23 fixed on the working segment 22 and having a toothed section 231 accommodated in the accommodating cavity 221, two engaging members 24 opposite to the toothed section 231, and two second springs 25 abutting against the two engaging members 24 which engage with the toothed section 231. The fitting portion 21 is a square column extending upwardly from the working head 23, such that the toothed section 231 engages with one of the two engaging members 24, and the working head 23 is limited to rotate in the single direction relative to the working segment 22.

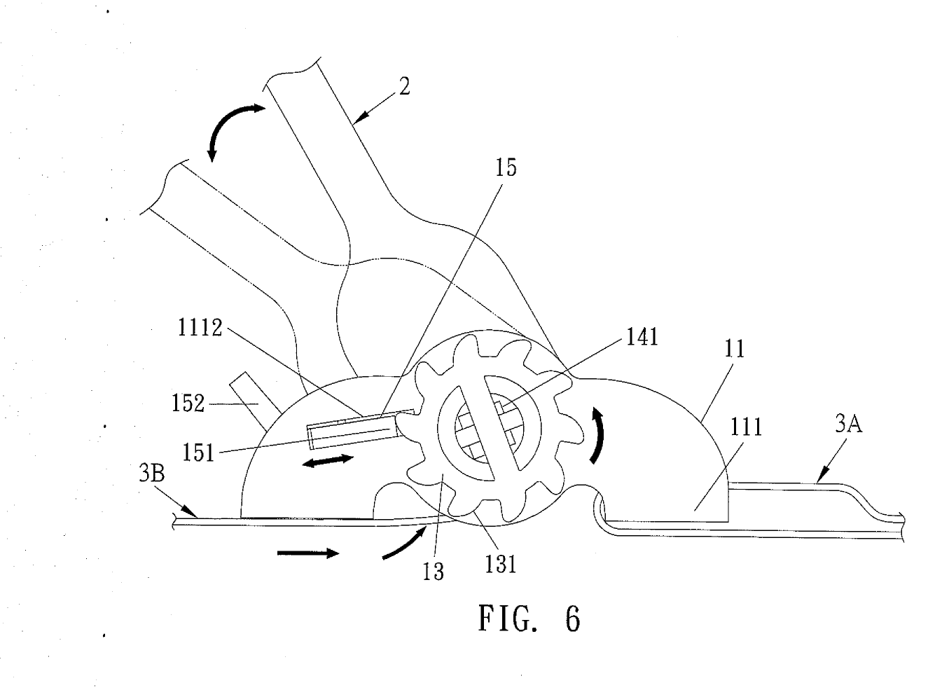

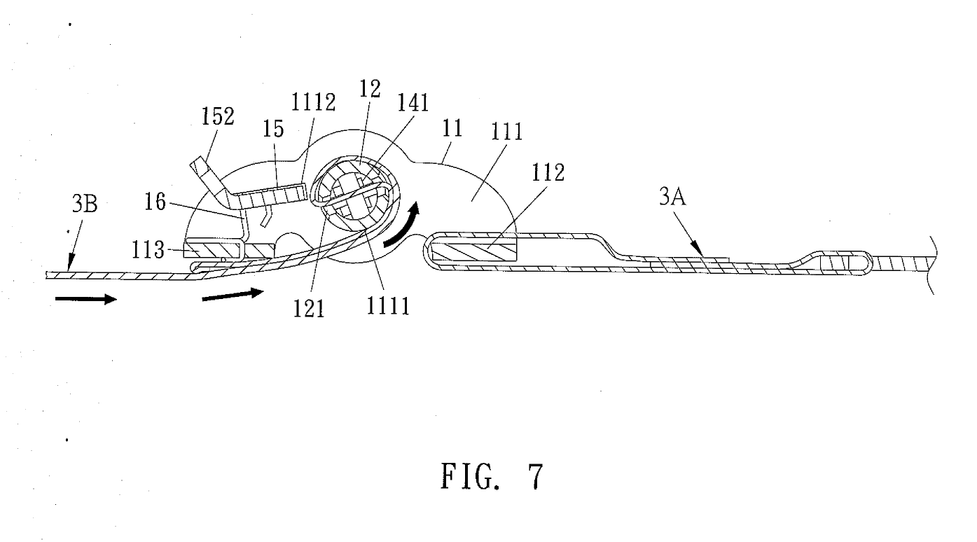

In operation, as shown in FIGS. 6 and 7, the fitting portion 21 of the rotating member 2 is movably fitted with the drive portion 141 of the driving member 14, the rotating member 2 drives the drive member 14 to rotate, and the rotary shaft 12 and the two ratchets 13 are driven by the drive portion 12 to rotate clockwise, wherein when the two ratchets 13 rotate clockwise, the retainer 15 reciprocally engages with the one of the plural teeth 131 of each ratchet 13 to stop each ratchet 13 rotating in a counterclockwise, and then the rotary shaft 12 rolls the movable section 3B, thereafter the rotating member 2 is removed from the drive portion 141 of the driving member 14.

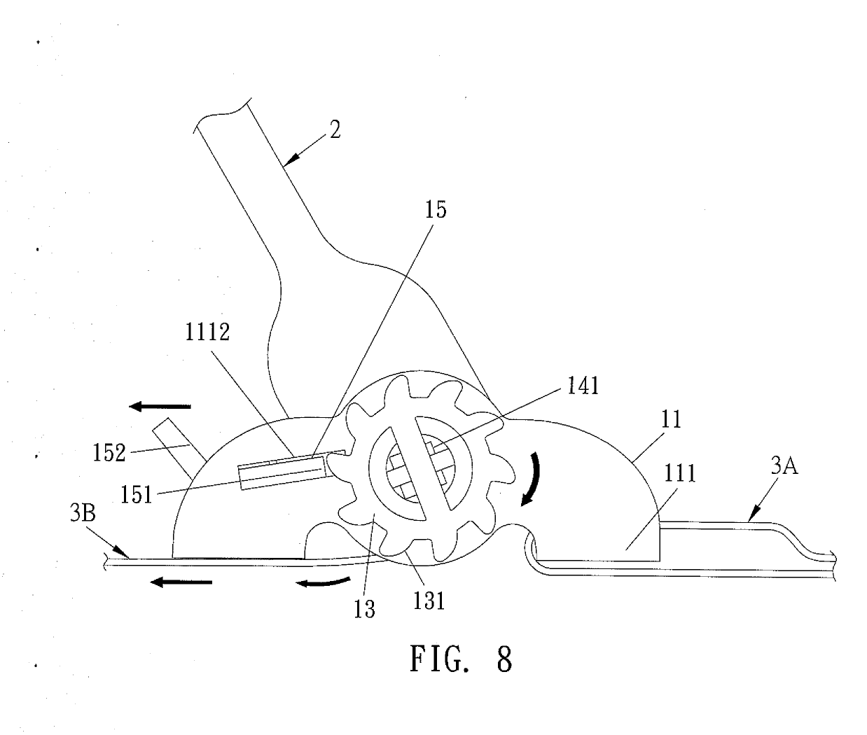

Referring further to FIG. 8, when the rotatable tab 152 of the retainer 15 is rotated away from the rotary shaft 12, each shoulder 151 of the retainer 15 disengages from the one of the plural teeth 131 of each ratchet 13, such that the rotary shaft 12 is rotated freely to remove the movable section 3B, and when releasing the retainer 15, the first spring 16 pushes the retainer 15 to move close to the rotary shaft 12, hence each shoulder 151 of the retainer 15 engages with the one of the plural teeth 131 of each ratchet 13.

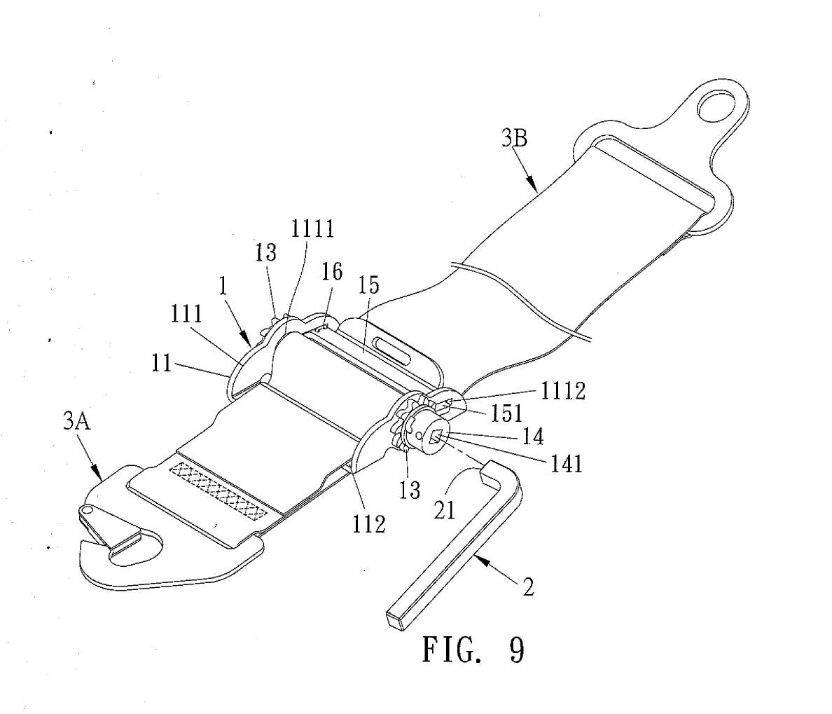

As illustrated in FIG. 9, in another embodiment, the rotating member 2 is an L-shaped wrench which includes a fitting portion 21, and the fitting portion 21 is a square column extending outwardly from one end thereof, such that the fitting portion 21 fits with the drive portion 141 of the driving member 14.

Thereby, the adjusting structure for the ratchet safety belt contains following advantages:
1. Each shoulder 151 of the retainer 15 engages with the one of the plural teeth 131 of each ratchet 13 without removal as vibration, and the rotating member 2 drives the driving member 14 and the rotary shaft 12 to revolve, thus rolling and pulling the movable section 3B tightly.
2. After rotating the rotatable tab 152 of the retainer 15 away from the rotary shaft 12, each shoulder 151 of the retainer 15 disengages from the one of the plural teeth 131 of each ratchet 13, thus releasing the retainer 15 easily.

While various embodiments in accordance with the present invention have been shown and described, it is clear to those skilled in the art that further embodiments may be made without departing from the scope of the present invention.

What is claimed is:

1. An adjusting structure for a ratchet safety belt comprising:
a body and a rotating member for matching with a fixed section and a movable section of a ratchet safety belt, the body including
a holder having two parallel side plates, a fixing plate defined on a first end between two sides of the holder, and an abutting plate arranged on a second end between the two sides of the holder, wherein the fixing plate is connected with the fixing section, each side plate has an orifice defined thereon and a slot formed adjacent to the orifice;
a rotary shaft inserting into and extending out of the orifice of each side plate, and the rotary shaft having a through hole defined on a middle section thereof to insert through the movable section of the ratchet safety belt;
two ratchets, each being coupled with each end of the rotary shaft which extends out of the orifice and rotates with each ratchet, and each ratchet has plural teeth arranged around a peripheral side thereof;
a driving member joined with one end of the rotary shaft which extends out of the orifice, such that the driving member rotates with the rotary shaft, and the driving member having a drive portion arranged on one end thereof away from the holder;
a retainer slidably mounted in two slots of the two side plates of the holder, wherein the retainer has two shoulders formed on two sides of a first end thereof and extending out of the two slots of the two side plates to limit a rotation of each ratchet along the rotary shaft in a single direction; and
a first spring fixed between the abutting plate and the retainer of the holder, such that the retainer is pushed by the first spring to move close to the rotary shaft, and each shoulder of the retainer engages with one of the plural teeth of each ratchet;
a rotating member including a fitting portion for fitting with the drive portion of the driving member to drive the driving member to rotate, and the rotary shaft and the two ratchets being driven by the rotary shaft to rotate, thus rolling and pulling the moving section of the racket safety belt tightly.

2. The adjusting structure for the ratchet safety belt as claimed in claim 1, wherein the rotating member is a ratchet wrench, and the ratchet wrench includes a working segment with an accommodating cavity defined in the working segment, a tool head fixed on the working segment and having a toothed section accommodated in the accommodating cavity, two engaging members opposite to the toothed section, and two second springs abutting against the two engaging members which engage with the toothed section, the fitting portion is a square column extending upwardly from the working head.

3. The adjusting structure for the ratchet safety belt as claimed in claim 1, wherein the rotating member is an L-shaped wrench which includes a fitting portion, and the fitting portion extends outwardly from one end thereof.

4. The adjusting structure for the ratchet safety belt as claimed in claim 1, wherein the drive portion of the driving member is a square aperture, and the fitting portion of the rotating member is a square column for corresponding to the square aperture.
